(19) United States
(12) Patent Application Publication
(10) Pub. No.: US 2006/0177059 A1
(43) Pub. Date: Aug. 10, 2006

(54) Printing apparatus, program and method

(75) Inventor: Daisuke Tanaka, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/126,180

(22) Filed: May 11, 2005

(30) Foreign Application Priority Data
Feb. 10, 2005 (JP) 2005-033861

(51) Int. Cl. H04N 1/44

(52) U.S. Cl. 380/243

(57) ABSTRACT

A printing apparatus includes a communication unit for receiving printing data from an external device; an identification unit for identifying the communication unit through which the printing data is received; a security setting unit for setting security for printing in association with the communication unit; security determination unit for determining whether the security setting for the identified communication unit is valid; and a control unit for controlling whether to execute printing of the printing data in accordance with a determination result of the security determination unit.

### BACKGROUND OF THE INVENTION

The present invention relates to a printing apparatus, program and method capable of using a user authentication function.

A technology has recently been proposed for protecting confidential data under an environment in which a plurality of users are present. Such conventional technologies known to the inventor are disclosed in documents as follows.

Patent document 1 discloses a printing system in which fingerprint data is added to printing data and the data is sent when a printing job is transmitted, and printing is performed when an authentication server determines that the fingerprint data matches fingerprint data sent from a printer.

Patent document 2 discloses a printing system in which authentication is performed at a printer by utilizing user's physical features associated with user ID, a password, and the like.

Patent document 3 discloses a printer which performs a printing operation by utilizing a user ID received from a host device.

However, there have been problems as described below in the conventional technologies.

First, authentication information (such as fingerprint, user ID, and password) is added to printing data to be transmitted. Thus, a dedicated printer driver or the like to be ready for handling an entry of such information is necessary, and a system that a user has used for a long time must be changed.

Second, it is necessary to install means for inputting the authentication information to be added to the printing data, in particular, a bio-authentication device such as a fingerprint authentication device, to each terminal. Thus, system introduction costs are increased.

Additionally, a technology of transmitting data by determining safety of a transfer path, and the like are disclosed in the following documents.

Patent document 4 discloses a data transfer system which determines safety of a transfer path up to an image forming device.

Patent document 5 discloses a printing method with which printing data is transmitted if a secure communication path exist when it is determined whether a secure communication path is present.

Patent document 6 discloses a printing system in which numerical data generated by random numbers or the like is transmitted through a transfer path beforehand and a storage medium storing the same numerical data is used, thereby security is ensured.

Patent document 7 discloses a printer system which can prevent a malfunction of a printer caused by mismatching between an interface that a user desires to use and an interface recognized by an external device.

[Patent document 1] JP 2001-51915 A

[Patent document 2] JP 2003-305905 A

[Patent document 3] JP 11-165446 A

[Patent document 4] JP 2004-15141 A

[Patent document 5] JP 2001-159960 A

[Patent document 6] JP 2003-330676 A

[Patent document 7] JP 2004-9628 A

### SUMMARY OF THE INVENTION

With the above-mentioned conventional technologies, it has not been easy to introduce a printer system in which high security is ensured only by setting on the printer side.

It is an object of the present invention to provide a printer which can assure high security only by setting on the printing apparatus side.

In order to achieve above-mentioned object, the present invention provides a printing apparatus including: communication unit for receiving printing data from an external device; identification unit for identifying the communication unit through which the printing data is received; security setting unit for setting security for printing in association with the communication unit; security determination unit for determining whether the security setting for the identified communication unit is valid; and control unit for controlling whether to execute printing of the printing data in accordance with a determination result of the security determination unit.

According to the present invention, security for printing is set in association with the communication unit, so that determination can be made as to whether the security setting is valid for the communication unit through which the printing data is received, and whether to execute printing of the printing data can be controlled. Thus, it is possible to set security for printing only by the printing side.

### DESCRIPTION OF THE DRAWINGS

FIG. 1 is an explanatory diagram showing an entire configuration of a printing apparatus security system including a network printing apparatus of an embodiment.

FIG. 2 is an explanatory diagram showing a configuration example of a printing apparatus of the embodiment.

FIG. 3 is an explanatory diagram showing a display configuration example of a user operation panel of the embodiment.

FIG. 4 is an explanatory diagram showing a registration procedure of security setting according to the embodiment.

FIG. 5 is a table showing an example of management information according to the embodiment.

FIG. 6 is a flowchart showing an operation procedure of the printing apparatus for which security is set according to the embodiment.

FIG. 7 is a diagram showing another configuration example of a printing apparatus security system according to the embodiment.

### DETAILED DESCRIPTION OF THE INVENTION

Hereinafter, an embodiment of the present invention will be described with reference to the drawings. A configuration of the embodiment is only an example, and in no way limitative of the present invention. It is to be noted that the present invention can be implemented by hardware and software. In a case of implementation by software constituted of a program, various functions can be realized by installing the program constituting the software in hardware such as a computer. The program is installed in the computer or the like by using a computer-readable storage medium (recording medium), or through a communication line.

Here, the computer-readable storage medium is a storage medium on which information such as data or a program is stored by an electric, magnetic, optical, mechanical, or chemical operation, and from which the information can be read by a computer. Among such storage media, media that can be removed from a computer are, for example, a flexible disk, a magneto-optical disk, a CD-ROM, a CD-R/W, a DVD, a DAT, an 8 mm tape, and a memory card. Storage media fixed to a computer include a hard disk and a read-only memory (ROM).

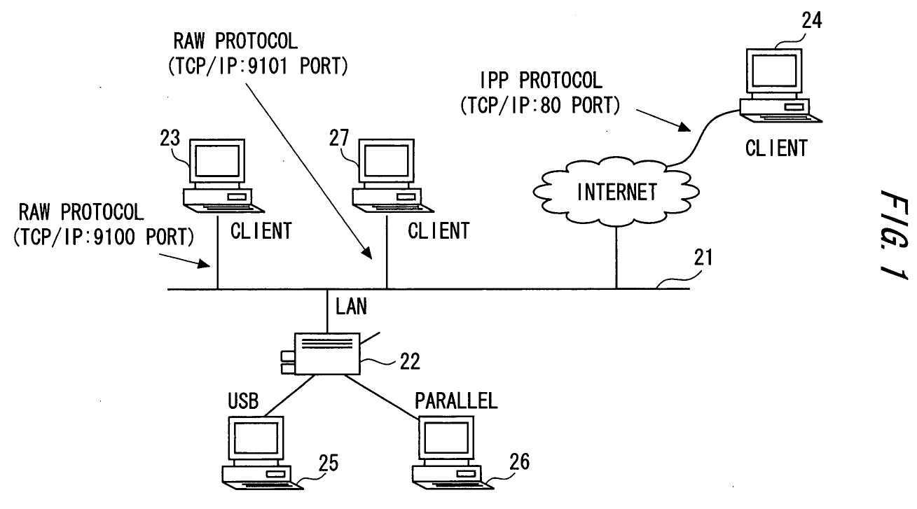

FIG. 1 is an explanatory diagram showing an entire configuration of a printing apparatus security system (security system) which includes a network printing apparatus of the embodiment. In FIG. 1, reference numerals 23 to 27 denote client devices, and a reference numeral 22 denotes a printing apparatus (network printing apparatus). A network 21 is a network such as a local LAN in a company.

The printing apparatus 22 includes three LAN/USB/parallel physical interfaces (compliant with IEEE 1284) (equivalent to “communication unit” of the present invention). The printing apparatus 22 is physically connected to the client device 25 through the USB interface, and to the client device 26 through the parallel interface by cables or the like, in a one-to-one relationship.

The printing apparatus 22 is physically connected to the client devices 23 and 27 by the LAN interface through the network 21. The network 21 is connected to the Internet, and the client device 24 is connected to the printing apparatus 22 through the Internet.

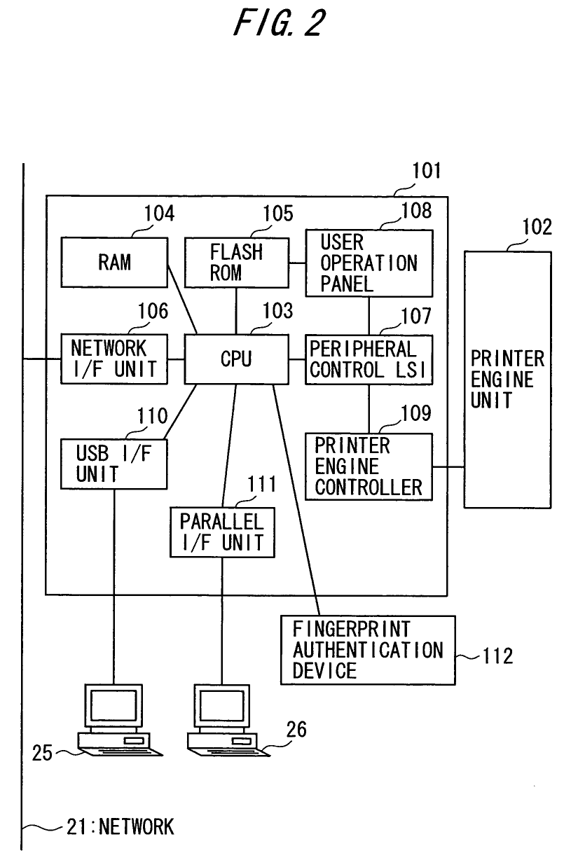

FIG. 2 is an explanatory diagram showing a configuration example of the printing apparatus 22 of the embodiment. The printing apparatus 22 includes a printing apparatus controller unit 101 and a printing apparatus engine unit 102.

The printing apparatus control unit 101 includes a central processing unit (CPU) 103 for performing various arithmetic operations, a random access memory (RAM) 104, a flash read-only memory (ROM) 105, a network I/F unit 106 for connecting with the network 21, a peripheral control LSI 107, a user operation panel 108, a printing apparatus engine controller unit 109, a USB I/F unit 110, a parallel I/F unit, and a fingerprint authentication device 112. The fingerprint authentication device 112 may be configured to connect with the printing apparatus controller unit 101 through an interface.

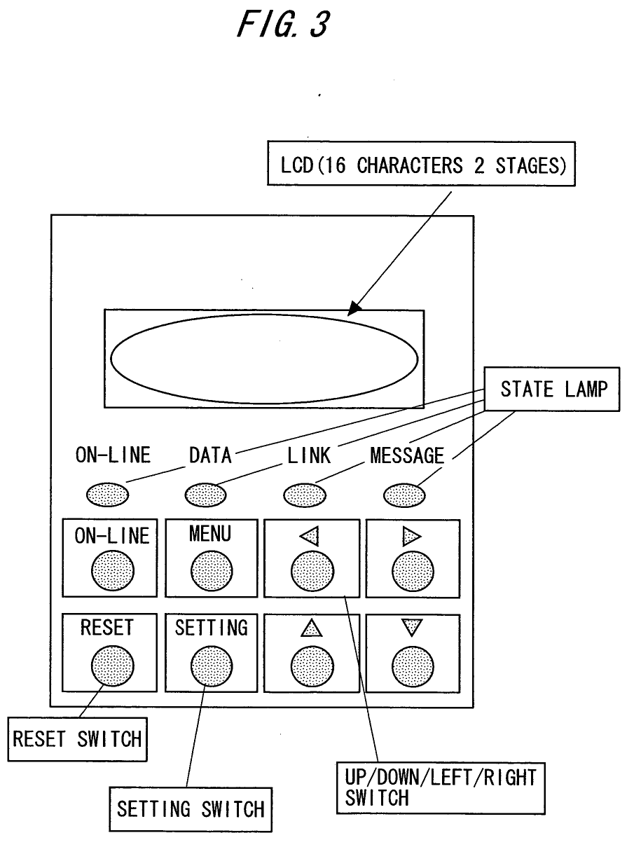

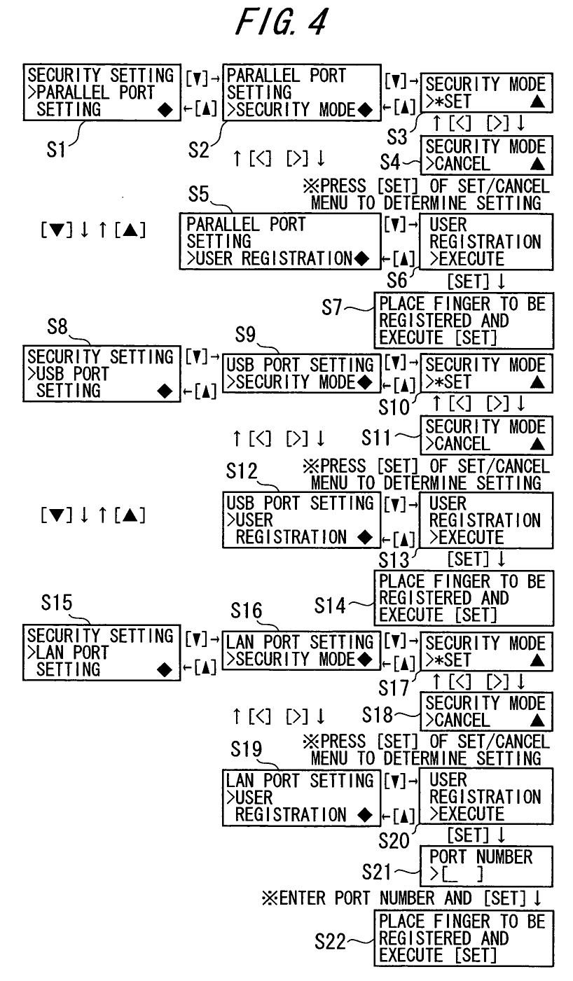

FIG. 3 is an explanatory diagram showing a display configuration example of the user operation panel of the embodiment. The user operation panel 108 includes a liquid crystal display (LCD), four light-emitting diodes (LED), and eight switches. According to the embodiment, as shown in FIG. 4, the LCD displays information to be in two lines of 16 characters in Japanese-language.

The printing apparatus 22 is controlled by expanding printing apparatus firmware stored in the flash ROM 105 on the RAM 104 by the CPU 103 and then executing a program on the RAM 104.

The RAM 104 includes a program storage area for storing the program to control the printing apparatus and a work storage area for storing printing data.

The printing apparatus 22 is connected to the network 21 through the network I/F unit 106, to the client device 25 through the USB I/F unit 110, and to the client device 26 through the parallel I/F unit 111.

The peripheral control LSI 107 controls the user operation panel 108 and the printing apparatus engine controller 109. The printing apparatus engine controller 109 controls the printing apparatus engine unit 102. The fingerprint authentication device 112 (equivalent to “security information input unit” of the present invention) is connected to the CPU 103 through an internal bus.

FIG. 4 is an explanatory diagram showing a registration procedure of security setting according to the embodiment. Before reception of printing data from each client device, a user displays a security setting menu as shown in FIG. 4, and performs security setting (equivalent to “security setting unit” of the present invention) in advance by operating the user operation panel 108 of the printing apparatus 22.

As shown in FIG. 4, on the security setting menu, the menu is classified into parallel/USB/LAN physical ports (left menu), and security can be set/canceled for each physical port.

On the “SECURITY SET” menu of FIG. 4, security becomes valid when “SET” is selected from a “SECURITY MODE” menu of a “PARALLEL PORT SETTING” menu, and a “SET” switch of the user operation panel 108 is pressed (S1 to S3).

In the case of canceling security setting, “CANCEL” is selected from the “SECURITY MODE” menu, and security can be canceled by pressing the “SET” switch (S4). Here, at the time of canceling the security, authentication of a registered user (fingerprint authentication, a password, or the like) may be requested, so that the security cannot be canceled by an illegal user.

When printing data is sent from the client device to a port for which security is canceled or a port for which security is not set (initial settings), the printing apparatus executes printing without performing authentication processing.

As an example of user registration, in FIG. 4, in the case of registering a user who is to use a parallel port, a screen for registering user's fingerprint is displayed when a “SET” switch is pressed on a “USER REGISTRATION” menu of a “PARALLEL PORT SET” menu (S5 to S7).

When a “SET” switch is pressed on a “PLACE FINGER TO BE REGISTERED AND EXECUTE [SET]” menu, user's fingerprint data is read from the fingerprint authentication device 112, and stored as digital data in the flash ROM 105 of the printing apparatus (S7). Here, the flash ROM 105 is used as a recording medium according to the embodiment. However, when a hard disk or other recording media can be used in the printing apparatus, the fingerprint data may be registered in such recording media.

In the case of a USB port, following the same procedure used in the case of the parallel port, “SET” and “CANCEL” of security setting and storing of user's fingerprint data are executed (S8 to S14).

In the case of a LAN port, following the same procedure used in the case of the parallel port, “SET” and “CANCEL” of security setting are executed (S15 to S18). In FIG. 14, a port number entry screen is displayed when the “SET” switch is pressed on the “USER REGISTRATION” menu (S19 to S21). Here, when each switch of the user operation panel 108 is operated to enter a port number to be used and then the “SET” switch is pressed, a screen for registering user's fingerprint data is displayed (S22) as in the case of the parallel/USB port.

Additionally, a numeric keypad for entering a port number to be used may be disposed in the user operation panel 108. Here, according to the embodiment, a configuration is employed in which the port number is entered through the LAN port. However, a configuration may be employed in which a screen for selecting a protocol is displayed and the user selects the protocol.

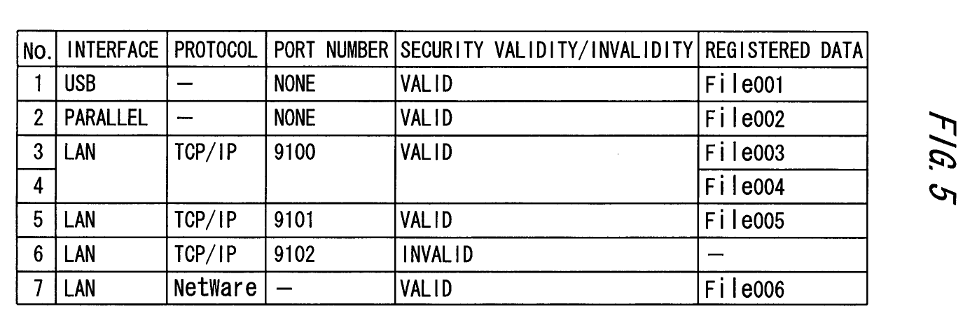

Following the above-described procedure, the CPU 103 stores security setting information, which is set as management information (management information table) of contents shown in FIG. 5, in the flash ROM 105 (equivalent to “authentication data registration unit” of the present invention).

The CPU 103 stores the setting information as the management information indicating security validity/invalidity for each of the interface/protocol/port number in the flash ROM 105 in association with the fingerprint data. Additionally, as shown in FIG. 5, a plurality of registration data can be stored in association with one port number.

The CPU 103 manages the stored fingerprint digital data, as registration data, on the management table. The fingerprint digital data is managed as a file, or as information on a digital data head address, a length or the like.

In the case of the management information of FIG. 5, if a LAN interface or a TCP/IP protocol is used, port 9100 and port 9101 each include management information different from each other, and thus different users can be allocated to each port.

According to the embodiment, the number of users to be registered for each of the parallel/USB/LAN interfaces is not limited. Thus, a plurality of users can be registered for the parallel port, or for the same port number of the LAN. However, a configuration may be employed in which the number of users to be registered is limited for each interface.

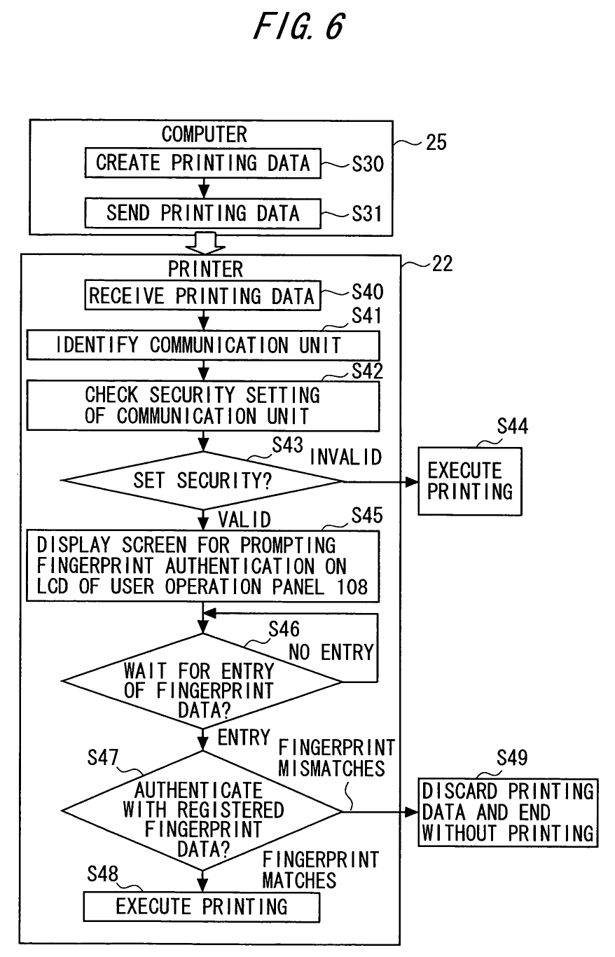

FIG. 6 is a flowchart showing an operation procedure of the printing apparatus 22 in which security has been set according to the embodiment. Hereinafter, detailed description will be made of an operation when printing data is sent from the client device 25 to the printing apparatus through the USB interface.

Various printing data such as documents or graphics are created by a computer 25 (S30). Upon reception of an instruction to execute printing, the computer 25 transmits the printing data to the printing apparatus 22 through the USB interface (S31).

The printing apparatus 22 receives the printing data and identifies a type of communication unit through which the printing data has been transmitted (equivalent to “identification unit” of the present invention) (S40 and S41). Referring to information on the management information table, the printing apparatus 22 determines whether security setting corresponding to the identified type of the communication unit (equivalent to “communication unit” of the present invention) is valid (equivalent to “security determination unit” of the present invention).

In the management information table shown in FIG. 5, security setting of the USB interface is “VALID”. Accordingly, a prompt for fingerprint authentication is displayed on the user operation panel 108 of the printing apparatus 22 (S43 and S44). Here, if the security setting of the USB interface is “INVALID”, printing is executed (S45). Thus, the CPU 103 controls printing execution of the printing data in accordance with a determination result of the security setting (equivalent to “control unit” of the present invention).

Next, the process waits for a user's finger to be placed on the fingerprint authentication device 112 for fingerprint data registration (S46). When the user's finger is placed on the fingerprint authentication device 112, the fingerprint data is input to the printing apparatus 22, and compared with registration data (File 001) registered beforehand in the printing apparatus 22 (S47).

Reading of a fingerprint is executed in such a configuration in which the fingerprint is detected by a pressure sensor disposed in a scanner unit of the fingerprint authentication device 112, or detected by pressing of a read button after the finger is placed. Then, printing is executed when the input fingerprint data matches with the registered data (S48). If the input fingerprint data does not match with the registered data, discarding of the printing data is executed (S49).

Here, according to the present invention, the fingerprint data is associated with each combination of the interface/protocol/port number and authenticated. That is, settings of Nos. 1 to 7 shown in FIG. 5 are determined to be different communication unit (types). In other words, even in the case of physically similar interfaces, the CPU 103 determines that a type of communication unit to be different when settings of a used protocol and a used port number are different.

Then, authentication is carried out by using the registered data (fingerprint data) associated with each communication unit. Printing is executed if the fingerprint data matches with the registered data (S48) If the fingerprint data does not match with the registered data, the printing data is discarded, and printing is not executed (S49).

The embodiment has been described by way of example in which the printing data is discarded and printing is not executed. However, the fingerprint authentication screen may be displayed repeatedly until a “RESET” switch of the user operation panel 108 is pressed, or the prescribed number of times of executing fingerprint authentication may be preset.

A screen for requesting fingerprint authentication repeatedly may be displayed until the prescribed number of times even if the fingerprint authentication fails, or the printing data is discarded only when the fingerprint authentication fails exceeding the prescribed number of times. If the printing data is discarded, a message saying “printing data has been discarded” may be temporarily displayed on the LCD.

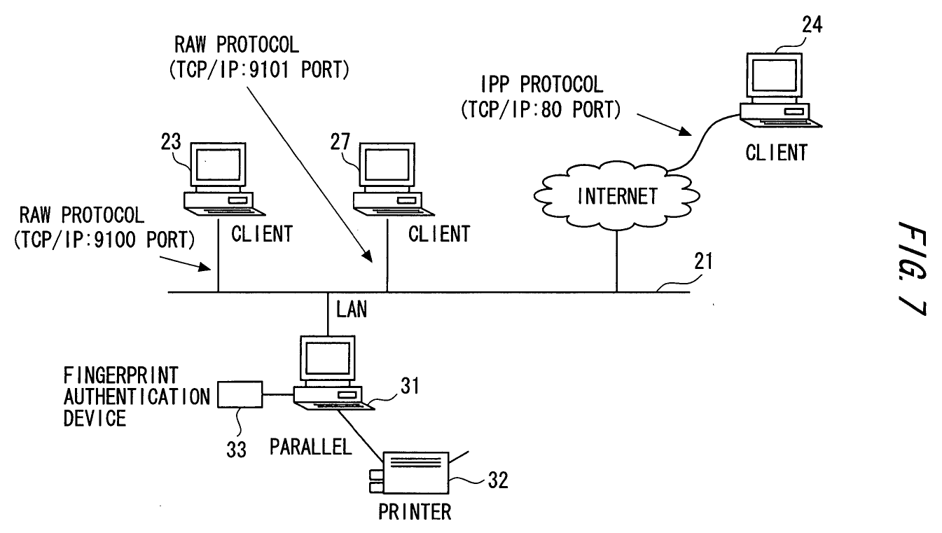

According to the embodiment, the printing apparatus 22 of FIG. 1 is configured as the printing apparatus 22 directly connected to the network 21. However, as shown in FIG. 7, a configuration may be employed in which a client device 31 is used as a printing apparatus server, and the client device 31 and a printing apparatus 32 are locally interconnected through a parallel cable.

In this case, an authentication device 33 is connected to the client device 31, and the program contained in the printing apparatus 22 of FIG. 1 for executing fingerprint data registration, authentication processing, or the like, can be realized as software on the client device.

According to the embodiment of the present invention, the following unique effects can be provided in the security printing apparatus system which includes the printing apparatus having the user authentication function, and the computer.

(1) By previously associating each communication unit with security authentication data, and executing authentication on the printing apparatus side for each communication unit through which printing data has been sent, high-level security can be realized irrespective of contents of the printing data. Accordingly, a driver or the like dedicated for each client device is made unnecessary, thereby limiting a change in user's system to a minimum. In other words, it is possible to realize high-level security by providing a new printing apparatus 22, or installing the program contained in the printing apparatus 22 for executing fingerprint data registration, authentication processing or the like, in the client device 31.

(2) In the system in which the computer and the printing apparatus are physically interconnected in a one-to-one relationship for each of the USB, the IEEE 1284 compliant parallel and other physical interfaces, it is possible to easily construct a high-level security system.

(3) Under the environment in which the plurality of computers and the printing apparatus are interconnected by the LAN interface through the network, authentication data (data regarding user's physical features, user ID, or password) can be registered for each communication protocol such as TCP/IP or NetWare, or each TCP/IP port number. Thus, it is possible to deal with user's security request with flexibility.

(4) According to the security authentication unit, the user ID, the password, or a combination of both is used as authentication information. Thus, it is possible to construct a security system without increasing cost for the printing apparatus.

(5) According to the authentication unit, user's physical features, such as a fingerprint, a vein, a retina, or a voiceprint is converted into digital data, and used as authentication information. Thus, it is possible to construct a security system which executes higher-level personal authentication.
(6) For the communication unit in which security setting is invalid, the printing can be executed without performing authentication. Accordingly, a user can flexibly have a choice of executing printing that needs security or executing printing that does not need security.

According to the present invention, high security can be assured only by setting on the printing apparatus side.

What is claimed is:

1. A printing apparatus comprising:
a communication unit that receives printing data from an external device;
an identification unit that identifies the communication unit through which the printing data is received;
a security setting unit that sets security for printing in association with the communication unit;
a security determination unit that determines whether the security setting for the identified communication unit is valid; and
a control unit that controls whether to execute printing of the printing data in accordance with a determination result of the security determination unit.

2. The printing apparatus according to claim 1, further comprising security information input unit that inputs information regarding user's physical features as authentication information.

3. The printing apparatus according to claim 2, further comprising authentication data registration unit that registers the authentication information in association with identification information indicating the communication unit.

4. The printing apparatus according to claim 2, wherein when the security determination unit determines the security setting to be valid, the control unit requests an entry of the authentication information from the security information input unit.

5. The printing apparatus according to claim 2, wherein the control unit compares the input authentication information with the authentication information registered by the authentication data registration unit, and executes printing of the printing data when both pieces of authentication information match with each other.

6. The printing apparatus according to claim 2, wherein the control unit compares the input authentication information with the authentication information registered by the authentication data registration unit, and discards the printing data when the pieces of authentication information do not match with each other.

7. The printing apparatus according to claim 1, wherein the security determination unit determines the security setting to be invalid, the control unit executes printing of the printing data.

8. The printing apparatus according to claim 1, wherein the identification unit determines an interface for physically interconnecting the external device and the printing apparatus in a one-to-one relationship to be different communication unit.

9. The printing apparatus according to claim 8, wherein the interface is a universal serial bus (USB or IEEE 1284 compliant parallel interface.

10. The printing apparatus according to claim 1, wherein when the external device and the printing apparatus are interconnected by a LAN interface through a network, the identification unit determines that a type of communication unit to be different for types of communication protocols.

11. The printing apparatus according to claim 10, wherein the LAN interface is a LAN interface of 100 BASE-TX or 10 BASE-T.

12. The printing apparatus according to claim 1, wherein when the external device and the printing apparatus are interconnected by a LAN interface through a network, the identification unit determines a type of communication unit to be different for port numbers.

13. The printing apparatus according to claim 2, wherein the security information input unit inputs user ID, a password, or a combination of the user ID and the password as the authentication information.

14. The printing apparatus according to claim 2, wherein the security information input unit converts user's physical features such as a fingerprint, a vein, a retina, or a voiceprint into digital data.

15. A printing program for a computer to execute:
a communication step of receiving printing data from an external device by communication unit;
an identification step of identifying the communication unit through which the printing data is received;
a security setting step of setting security for printing in association with the communication unit;
a security determination step of determining whether the security setting for the identified communication unit is valid; and
a control step of controlling whether to execute printing of the printing data in accordance with a determination result of the security determination step.

16. The printing program according to claim 15, further comprising a security information input step of inputting information regarding user's physical features as authentication information.

17. The printing program according to claim 16, further comprising an authentication data registration step of registering the authentication information in association with identification information indicating the communication unit.

18. A printing method comprising:
a communication step of receiving printing data from an external device by communication unit;
an identification step of identifying the communication unit through which the printing data is received;
a security setting step of setting security for printing in association with the communication unit;
a security determination step of determining whether the security setting for the identified communication unit is valid; and
a control step of controlling whether to execute printing of the printing data in accordance with a determination result of the security determination step.

19. The printing method according to claim 18, further comprising a security information input step of inputting information regarding user's physical features as authentication information.

20. The printing method according to claim 19, further comprising an authentication data registration step of registering the authentication information in association with identification information indicating the communication unit.
